(19) United States
(12) Patent Application Publication
(10) Pub. No.: US 2018/0110243 A1
(43) Pub. Date: Apr. 26, 2018

(54) System of gluten free flours

(71) Applicant: Millie J Westley, Stafford, VA (US)

(72) Inventor: Millie j Westley, Stafford, VA (US)

(21) Appl. No.: 15/793,792

(22) Filed: Oct. 25, 2017

Related U.S. Application Data
(60) Provisional application No. 62/412,282, filed on Oct. 25, 2016.

(51) Int. Cl. A23L 7/10; A23L 19/15; A23L 29/212; A23L 29/238; A21D 2/18; A21D 10/00

(52) U.S. Cl. CPC A23L 7/198; A23L 19/15; A23L 29/212; A23L 29/238; A23V 2200/126; A21D 2/186; A21D 10/005; A23V 2002/00; A21D 2/183

(57) ABSTRACT

Food product compositions provide for gluten free or gluten-reduced food products having organoleptic properties that are the same or substantially the same as their gluten-containing food product counterparts, and related methods for making the compositions thereof.

At least one embodiment is gluten dry mix compositions consisting substantially of rice flour, sweet rice flour, oat flour, and millet flour, buckwheat flour, teff flour, potato flour, xanthan gum, gaur gum and maltodextrin.

At least one embodiment is gluten dry mix compositions consisting substantially of oat flour, and millet flour, buckwheat flour, teff flour, potato flour, xanthan gum, gaur gum and maltodextrin.

At least one embodiment is gluten dry mix compositions consisting substantially of rice flour, sweet rice flour, oat flour, and millet flour, buckwheat flour, teff flour, potato flour.

At least one embodiment is gluten dry mix compositions consisting substantially of oat flour, and millet flour, buckwheat flour, teff flour, potato flour.

### RELATED APPLICATIONS

This application claims the benefit under 35 U.S.C. § 119(e) of U.S. provisional patent application Ser. No. 61/536,384, filed Sep. 19, 2011, the contents of which is incorporated herein by reference in its entirety.

### BACKGROUND OF THE INVENTION

Gluten is a protein composite found in foods processed from wheat and related species, including barley and rye. It imparts elasticity to dough, helping it to rise and to keep its shape, and often giving the final product a chewy texture. Between 0.5 and 1.0 percent of people in the United States are sensitive to gluten due to Celiac Disease {Consensus Development Panel on Celiac Disease. National Institutes of Health (NIH) (2005)).

When people with Celiac Disease eat foods containing gluten, their immune system responds by damaging tiny fingerlike protrusions, called villi. Villi lining the small intestines are responsible for the absorption of nutrients into the bloodstream. If villi become damaged or destroyed and are unable to absorb nutrients, a person becomes malnourished, irrespective of the quantity of the food consumed. Symptoms associated with Celiac Disease include recurring abdominal bloating and pain, chronic diarrhea, weight loss, fatigue, delayed growth, and failure to thrive in infants.

The only medically accepted treatment for Celiac Disease is to follow a gluten-free diet, eliminating virtually all foods made from grains that contain gluten. It is difficult for individuals following such a diet to find gluten-free options, for example, at restaurants and local convenience stores. Many of the commercially-available gluten-free food options made using gluten-free flour substitutes lack the pleasurable organoleptic properties of foods made using grains that contain gluten {e.g., wheat flour-based bread). Food products prepared using existing all-purpose gluten-free flour substitutes have, more often than not, a strong bitter or sour aftertaste, and/or poor texture.

### SUMMARY OF THE INVENTION

Described herein are compositions, and related methods, that provide for gluten-free or gluten-reduced food products having, in many embodiments, organoleptic properties that are the same or substantially the same as their gluten-containing food product counterparts. Food products (e.g., bread, crackers, pizza dough, muffin, brownies) made using existing all-purpose gluten-free flour substitutes typically require additional ingredients, depending on the type of food, to compensate for a particular desired property of the food. For example, it is often necessary to include additional amounts of gum (thickening agent) to a food product, the amount of the gum varying depending on the food (e.g., less for a cookie, more for pie crust). An otherwise simple recipe can become a complex experiment in trying to determine what mixture of gluten-free ingredients will achieve a final food product comparable to its gluten-containing counterpart.

Provided herein, in certain embodiments, is an gluten-free dry mix substitute for gluten-containing flours (e.g., wheat, barley, and/or rye flour), which imparts into the food product pleasurable organoleptic properties (e.g., mouthfeel) comparable to the properties of counterpart gluten-containing food products.

In some embodiment, provided herein are Gluten free dry mix compositions comprising oat flour and one or more flour. In some embodiment, provided herein are Gluten free dry mix compositions comprising oat flour, millet flour and one or more flour. Such flours could include, for example; vegetable flours, refined flours, whole or nearer whole grain flours. These could include, for example, rice flour, sweet rice flour, buckwheat flour, millet flour, grain flour, sorghum, teff flour potato flour. In some aspects, provided herein are Gluten free dry mix compositions comprising oat flour, white rice flour, sweet rice flour, buckwheat, millet flour, potato flour. In some aspects, provided herein are Gluten free dry mix compositions comprising oat flour, buckwheat, millet flour, potato flour. In some embodiments, the Gluten free dry mix compositions further comprise one or more gums, such as xanthan gum, guar gum. In some embodiments, the Gluten free dry mix compositions further comprise ginger. In some embodiments, the Gluten free dry mix compositions further comprise an emulsifier or maltodextrin. In some embodiments, the Gluten free dry mix compositions further comprise ascorbic acid Hydrocolloids or gums, can be added to Gluten free dry mix to give structure to the dough and bind ingredients (i.e., to create a suitable matrix within the dough in the absence of gluten). For example, hydrocolloids may be added to improve the rheology and crumb texture by stabilizing small air cells within the dough/batter and bind to moisture. Hydrocolloids are hydrophilic polymers that contain hydroxyl groups and may be polyelectrolytes. Suitable hydrocolloids may be of vegetable, animal, microbial or synthetic origin. Suitable hydrocolloids include xanthan gum, guar gum, locust bean gum, carrageenan gum and the like. In some embodiments, hydrocollodis or gums may be present in an amount from about 0.01% to about 2% by weight of the dough.

There are a wide range of wheat flours, all-purpose flour, cake flour, bread flour, high gluten flour, whole wheat flour, whole wheat bread flour. We can emulate this by adjusting the ratios of ingredients of the gluten free dry composition. In some embodiments, the percentage of one or more of the buckwheat, oat flour, less refined grain flour, millet flour, is increased to get a higher fiber version. In some embodiments, the percentage of one or more of the buckwheat, oat flour, grain flour, millet flour, is decreased to get a lower fiber version. In some embodiments, an ingredient is eliminated to adjust for those with additional restrictions. For example, in some embodiments, there is no rice flours. In some embodiments, the oat flour is present in an amount of about 50% to about 90% weight/weight (w/w) of the dry mix composition. In some embodiments, the oat flour is present in an amount of about 10% to about 50% weight/weight (w/w) of the dry mix composition.

In some embodiments, the millet flour, rice flour, sweet rice, grain flour, and potato flour are collectively present in an amount of about 10% to about 50% w/w of the dry mix composition. In some embodiments, the millet flour, rice flour, sweet rice, and potato flour are collectively present in an amount of about 50% to about 90% w/w of the dry mix composition. In some embodiments, the millet flour, buckwheat, and potato flour are collectively present in an amount of about 10% to about 50% w/w of the dry mix composition. In some embodiments, the millet flour, buckwheat, grain flour and potato flour are collectively present in an amount of about 50% to about 90% w/w of the dry mix composition. In some embodiments, without oat flour, comprise a grain flour (such as sorghum flour, tef flour, etc) and millet flour, potato flour. In some embodiments, a grain flour, millet flour, potato flour, and potato flour are collectively present in an amount of about 10% to about 50% w/w of the dry mix composition. In some embodiments, a less refined grain flour, millet flour, potato flour, and potato flour are collectively present in an amount of about 50% to about 90% w/w of the dry mix composition. In some embodiments, oat flour, millet flour, and potato flour are collectively present in an amount of about 10% to about 50% w/w of the dry mix composition. In some embodiments, oat flour, millet flour, and potato flour are collectively present in an amount of about 50% to about 90% w/w of the dry mix composition. In some of said embodiments, there are not gums or emulsifiers. In some of said embodiments, there are gums and/or emulsifiers.

Hydrocolloids or gums, can be added to the dough formulation to give structure to the dough and bind ingredients (i.e., to create a suitable matrix within the dough in the absence of gluten). For example, hydrocolloids may be added to improve the rheology and crumb texture by stabilizing small air cells within the dough and bind to moisture. Hydrocolloids are hydrophilic polymers that contain hydroxyl groups and may be polyelectrolytes. Suitable hydrocolloids may be of vegetable, animal, microbial or synthetic origin. Suitable hydrocolloids include xanthan gum, guar gum, locust bean gum, carrageenan gum and the like. In some embodiments, hydrocollodis or gums may be present in an amount from about 0.01% to about 2% by weight of the dough. In some embodiments, the ready-to-bake pizza dough may include one or more natural and/or synthetic bread flavors. In some embodiments, the ready-to-bake pizza dough may include a bread flavoring agent containing ethanol. The ethanol may also provide microbiological benefits. The ethanol may be present in an amount ranging from about 1% by weight to about 2% by weight of the composition. In some embodiments, the ready-to-bake dough may include one or more antimycotic agent(s) to enhance microbial stability. Useful agents include sorbic acid and its derivatives such as sodium or potassium sorbate, propionic acid and its derivatives, vinegar, sodium diacetate, monocalcium phosphate, lactic acid, citric acid and the like. These agents are present in an amount effective to inhibit the growth of undesired yeast and/or molds, typically in amount from about 0.1% to about 0.2% by weight of the dough. Too little will not provide sufficient antimycotic effect, while too much can impart an off taste to the dough. In some embodiments, at least one of the following texture additions; xanthan gum, gaur gum, ginger, ascorbic acid, maltodextrin, dextrin, emulsifiers, psyllium, stabilizers, (including ones yet to be determined) is present in an amount ranging between about 0.001% w/w and about 5% w/w or of about 1% w/w of the dry mix composition is texture additions. In some embodiment there are no texture additions. In some embodiment there is very little texture additions.

In some aspects, provided herein are gluten-free dry mix compositions consist essentially oat flour are present in an amount of about 50% to about 90% weight/weight (w/w) of the dry mix composition; millet flour, buckwheat and/or grain flour, and potato flour are collectively present in an amount of about 10% to about 50% w/w of the dry mix composition; with or without texture additions in an amount of about 1% w/w of the dry mix composition. In some aspects, provided herein are gluten-free dry mix compositions consist essentially oat flour are present in an amount of about 10% to about 50% weight/weight (w/w) of the dry mix composition; millet flour, buckwheat and/or grain flour, and potato flour are collectively present in an amount of about 50% to about 90% w/w of the dry mix composition; with or without texture additions in an amount of about 1% w/w of the dry mix composition.

In some embodiments, the dry mix compositions do not comprise any added starch. In some embodiments, the dry mix compositions do not comprise any added modified starch. In some embodiments, the dry mix compositions do not comprise a bean flour. In some embodiments, the dry mix compositions do not comprise a gum. In some embodiments, the dry mix compositions do not comprise sorghum flour. In some embodiments, the dry mix compositions do not comprise any added corn starch. In some embodiments, the dry mix compositions do not comprise any added tapioca. In some embodiments, the dry mix compositions do not comprise any added xanthan gum. In some embodiments, the dry mix compositions do not comprise any added gaur gums. In some embodiments, the dry mix compositions do not comprise any added gums. In some embodiments, the dry mix compositions do not comprise any added rice. In certain embodiments, tapioca flour is excluded from the dry mix compositions described herein. A composition for making a gluten-free product, comprising a gluten-free gas-retaining polymer, and a gluten-free setting polymer. A composition for gluten-free baked product comprising a native starch pregelatinized or precooked, fibers of plant origin chosen from fibers legume.

In some aspects, provided herein are methods of preparing any of the gluten-free dry mix compositions described herein, the methods comprising blending oat flour and millet flour are present in an amount of about 50% to about 99% weight/weight (w/w) of the dry mix composition; millet flour, buckwheat and/or oat flour and/or grain flour, and potato flour are collectively present in an amount of about 1% to about 50% w/w of the dry mix composition. This collective amount, in some embodiments texture additions in an amount of about 1% w/w of the dry mix composition. This collective amount, in some embodiments, includes buckwheat flour. This collective amount, in some embodiments, includes teff flour. This collective amount, in some embodiments, includes potato flour. In some aspects, provided herein are methods of preparing any of the gluten-free dry mix compositions described herein, the methods comprising blending oat flour and millet flour are present in an amount of about 1% to about 50% weight/weight (w/w) of the dry mix composition; millet flour, buckwheat and/or oat flour and/or grain flour, and potato flour are collectively present in an amount of about 50% to about 99% w/w of the dry mix composition. This collective amount, in some embodiments texture additions in an amount of about 1% w/w of the dry mix composition. This collective amount, in some embodiments, includes buckwheat flour. This collective amount, in some embodiments, includes teff flour. This collective amount, in some embodiments, includes potato flour. This collective amount, in some embodiments, includes potato flour. This collective amount, in some embodiments, includes rice flour. This collective amount, in some embodiments, includes sweet rice flour.

In some aspects, provided herein are gluten-free food products comprising any of the gluten-free dry mix compositions described herein. In other aspects, provided herein are gluten reduced food products comprising any of the gluten-free dry mix compositions described herein.

In some aspects, provided herein are methods of preparing a food product based on a recipe that requires wheat, barley or rye flour and at least one other ingredient, said methods comprising combining any of the gluten-free dry mix compositions described herein with the at least one other ingredient in the recipe, wherein the wheat, barley, or rye flour ingredient is substituted with an equivalent amount of the gluten-free dry mix composition, and wherein the prepared food product is gluten-free.

In some embodiments, provided herein are methods of preparing a food product based on a recipe that requires wheat, barley or rye flour and at least one other ingredient, said method comprising combining oat flour, millet flour, millet flour, and potato flour, rice flour and/or sweet rice flour with the at least one other ingredient in the recipe, wherein the wheat, barley, or rye flour ingredient is substituted with an equivalent amount of oat flour, millet flour, and potato flour, rice flour and/or sweet rice flour, wherein a Gluten free food product is prepared.

In some aspects, provided herein are methods of preparing a food product based on a recipe that requires wheat, barley or rye flour and at least one other ingredient, said method comprising combining oat flour, millet flour, and potato flour, with the at least one other ingredient in the recipe, wherein the wheat, barley, or rye flour ingredient is substituted with an equivalent amount of oat flour, millet flour, and potato flour, and wherein a Gluten free food product is prepared.

In some aspects, provided herein are methods of preparing a food product based on a recipe that requires wheat, barley or rye flour and at least one other ingredient, said method comprising combining oat flour in an amount of about 20% to about 50% w/w of the dry mix composition; rice flour and/or sweet rice flour, millet flour in an amount of about 50% to about 80% w/w of the dry mix composition; with the at least one other ingredient in the recipe, wherein the wheat, barley, or rye flour ingredient is substituted with an equivalent amount oat flour in an amount of about 20% to about 50% w/w of the dry mix composition; rice flour and/or sweet rice flour, millet flour in an amount of about 50% to about 80% w/w of the dry mix composition; and wherein a gluten-free food product is prepared. In some aspects, provided herein are methods of preparing a food product based on a recipe that requires wheat, barley or rye flour and at least one other ingredient, said method comprising combining oat flour in an amount of about 50% to about 90% w/w of the dry mix composition; rice flour and/or sweet rice flour, millet flour in an amount of about 10% to about 50% w/w of the dry mix composition; with the at least one other ingredient in the recipe, wherein the wheat, barley, or rye flour ingredient is substituted with an equivalent amount oat flour in an amount of about 50% to about 90% w/w of the dry mix composition; rice flour and/or sweet rice flour, millet flour in an amount of about 10% to about 50% w/w of the dry mix composition; and wherein a gluten-free food product is prepared. In an aspect, in some embodiments, includes uses another less refined flour in place of the oat flour. In some aspects include at least one of xanthan gum, gaur gum, an emulsifier. In an aspect, in some embodiments, includes uses a less refined flour, for example teff, buckwheat, sorghum, an ancient grain. In some embodiments the amount of flour is significantly different than the original recipe. For example bread recipes often require different a amount of flour.

In some embodiments, the additional ingredients not listed in the recipe are excluded from the gluten-free food product and the amount of each ingredient in the recipe is not altered. In some embodiments, the additional ingredients not listed in the recipe are excluded from the gluten-reduced food product and the amount of each ingredient in the recipe is not altered.

In some aspects, provided herein are gluten-free food products prepared by any of the methods described herein. In other aspects, provided herein are gluten-reduced food products prepared by any of the methods described herein.

In some embodiments, the food product is selected from the group consisting of angel food cake, biscotti, biscuits, Boston cream pie, bread pudding, bread, dinner roll, dough, doughnuts, brownie, bundt cake, cakes (e.g., wedding cakes), cinnamon rolls, cookie, cheese cake, chips, cracker, croissants, cupcakes, danish, eclair, florentine, French pastries, fruit cakes, fudge, coffee cakes, lemon squares, liqueur cake, loaf, muffin, noodles, pasta, pie dough, puff pastry turnover, pancake, pie, pineapple upside down cake, pizza dough, pretzels, quiche, quick bread, red velvet cake, sticky bun, strudel, stuffing, tart, tiramisu, torte, tres leche cake and trifle.

In some aspects, provided herein are gluten-reduced food products comprising any of the gluten-free dry mix compositions described herein and one or more additional gluten-containing ingredients. In some embodiments the amount of flour is significantly different than the original recipe. For example bread recipes often require different a amount of flour.

In some aspects, provided herein are prepackaged gluten-free food product kits comprising any of the gluten-free dry mix compositions described herein and a recipe or directions for obtaining a recipe for preparing a food product using the gluten-free dry mix composition. In other aspects, provided herein are prepackaged gluten-reduced food product kits comprising any of the gluten-free dry mix compositions described herein and a recipe or directions for obtaining a recipe for preparing a food product using the gluten-free dry mix composition.

In some embodiments, the kits further comprise at least one additional ingredient that is listed in the recipe.

In some aspects, provided herein are gluten-free dry mix compositions comprising rice flour, sweet rice flour, oat flour, millet, buckwheat flour, teff flour, potato flour, xanthan gum, maltodextrin, gaur gum. In some aspects, provided herein are gluten-free dry mix compositions comprising oat flour, millet, buckwheat flour, teff flour, potato flour, xanthan gum, maltodextrin, gaur gum. In some aspects, provided herein are gluten-free dry mix compositions comprising rice flour, sweet rice flour, oat flour, millet, buckwheat flour, teff flour, potato flour. In some aspects, provided herein are gluten-free dry mix compositions comprising flour, oat flour, millet, buckwheat flour, teff flour, potato flour. In some aspects, provided herein are gluten-free dry mix compositions comprising rice flour, oat flour, millet, buckwheat flour, teff flour, potato flour, xanthan gum, maltodextrin, gaur gum. In some aspects, provided herein are gluten-free dry mix compositions comprising rice flour, oat flour, millet, buckwheat flour, teff flour, potato flour.

In some embodiments, different embodiments can be combined to create a blend that will work best for a certain recipe. By the way of example, but not limited to, an embodiment for cakes and an embodiment for cookies, can be combined for banana bread. By this method, a few flours and combine them in various rations for many more recipes. This method could also be used for other blend.

While multiple embodiments are disclosed, still other embodiments of the present invention will become apparent to those skilled in the art from the following detailed description, which shows and describes illustrative embodiments of the invention. Accordingly, the drawings and detailed description are to be regarded as illustrative in nature and not restrictive.

### DETAILED DESCRIPTION OF THE EMBODIMENTS

Described herein are gluten-free dry mix compositions, which can be used to substitute gluten-containing flours, such as wheat, rye, and barley flour. The inventive gluten-free dry mix compositions may contain a mixture of gluten-free flour(s), starch(es), and thickening agent(s). In certain embodiments, the gluten-free dry mix compositions comprise rice flour, sweet rice flour, oat flour, millet flour, buckwheat flour, teff flour, potato flour. In certain embodiments, the inventive compositions comprise or consist essentially of super fine white rice flour, sweet rice flour, buckwheat and/or oat flour, millet flour, potato flour. In certain embodiments, the amount of oat flour in a gluten-free dry mix composition is about 10% to about 50% w/w of the composition, and the remaining components are present in an amount of about 50% to about 90% w/w of the composition. In some embodiments the composition will include rice flour. In some embodiments the composition will include sweet rice flour. In certain embodiments, the amount of oat flour in a gluten-free dry mix composition is about 50% to about 90% w/w of the composition, and the remaining components are present in an amount of about 10% to about 50% w/w of the composition. In some embodiments the composition will include rice flour. In some embodiments the composition will include sweet rice flour. In certain embodiments, the gluten-free dry mix compositions comprise oat flour, millet flour, buckwheat flour, teff flour, potato flour. In certain embodiments, the inventive compositions comprise or consist essentially of super fine white rice flour, sweet rice flour, buckwheat and/or oat flour, millet flour, potato flour. In certain embodiments, the amount of oat flour in a gluten-free dry mix composition is about 10% to about 50% w/w of the composition, and the remaining components are present in an amount of about 50% to about 90% w/w of the composition. In some embodiments the composition will include rice flour. In some embodiments the composition will include sweet rice flour. In certain embodiments, the amount of oat flour in a gluten-free dry mix composition is about 50% to about 90% w/w of the composition, and the remaining components are present in an amount of about 10% to about 50% w/w of the composition. In some embodiments the composition will include rice flour. In some embodiments the composition will include sweet rice flour. In particular embodiments, the amount of texture additives is about 1% w/w of the composition. In some embodiments the composition will include buckwheat flour. In some embodiments the composition will include teff flour. In some embodiments the composition will include grain bran. In some embodiments the composition will include grain germ. In some embodiments the composition will include less refined grain. In some embodiments the composition will include more refined grain.

Also disclosed herein relate are gluten-free or gluten-reduced food products and methods of preparing such food products. Also disclosed are prepackaged gluten-free or gluten-reduced food product kits comprising any one of the gluten-free dry mix compositions described herein, a recipe for preparing a food product using the gluten-free dry mix composition, and, optionally, at least one additional ingredient (without or without gluten) that is listed in the recipe. In some embodiments the amount of flour is significantly different than the original recipe. For example bread recipes often require different a amount of flour.

In addition to the foregoing, other ingredients known to those of skill in the art can be included in the compositions to give a variety of desired properties, flavors and/or textures. Examples of these ingredients include flavoring and coloring agents, flavors, spices, and the like.

### I. Definitions

“Dry mix composition” refers to a substantially dry (no added water) mixture of edible ingredients, for example, flours, starches, gums, and the like. In some embodiments, the dry mix compositions described herein are gluten-free or gluten-reduced. A “gluten-free” composition refers to a composition substantially without (essentially free of) gluten protein. In some embodiments, a gluten-free dry mix composition and the ingredients/components used to prepare a composition provided herein are obtained from gluten-free facilities; that is, such facilities do not manufacture or use equipment that comes into contact with products that contain gluten. In certain embodiments, a dry mix composition may have trace amounts of gluten protein (e.g., detectable but not able to be readily quantified). If, for example, the ingredients used to prepare an inventive dry mix composition are processed in a facility that is not gluten-free, cross-contamination from gluten-containing ingredients to intended gluten-free ingredients can occur, resulting in supposedly gluten-free ingredients having trace amounts of gluten. It is understood that such dry mix compositions having trace amounts of gluten may be used to prepare gluten-reduced food products, but they should not be used to prepare gluten-free products. Even trace amounts of gluten protein can be detrimental to certain individuals with Celiac Disease or those with a sensitivity or allergy to gluten.

“Equivalent amount” refers to a 1:1 substitution of one ingredient for another. For example, if a recipe requires 1 cup (about 1 cup) of wheat flour, an equivalent amount of the gluten-free dry mix composition is 1 cup (about 1 cup). Some recipes will require substantially different amount of flour, or an adjustment to the recipe will help.

“Food product” refers to a food, beverage, ingredient thereof or nutritional supplement that can be consumed to provide nutritional support for the body. A food product typically contains essential nutrients, such as carbohydrates, fats, proteins, vitamins, and/or mineral. A food product encompasses, but is not limited to, natural (unmodified) foods, organic foods, and composite foods made of one or more ingredients. A food product can be raw or cooked (e.g., baked, grilled, or fried). Any one of the food products described herein can be or comprise one or more fruit, vegetable, seed, grain, meat, fish, poultry, dairy product (e.g., milk, yogurt, cheese, etc.), or the like. Any one of the food products may also comprise added flavoring agents or sweeteners and the like. They may also include antioxidant food additives, such as ascorbic acid (i.e., vitamin C).

“Ginger” (also referred to as root ginger) means the rhizome of the plant Zingiber officinale and preparations made therefrom (e.g., ginger powder, ginger extract, etc.). Ginger, including for example root ginger or ginger powder (e.g., 100% ginger or a mixture of ginger and other spices), may optionally be present in any one of the gluten-free or gluten-reduced dry mix compositions described herein. Ginger can affect yeast activity, for example, it can increase yeast activity. In some instances, the addition of ginger to a bread recipe can affect how high the bread rises. Other members of this ginger plant family are turmeric, cardamom, and galangal, and in some embodiments, turmeric, cardamom, or galangal may be present in a dry mix composition. In some embodiments, cinnamon is present in a dry mix composition. Cinnamon, like ginger, affects yeast; however, cinnamon typically decreases the activity of yeast.

“Gluten” refers to an amorphous ergastic protein composite found in the endosperm of most cereals. It constitutes about 80% of the proteins contained in wheat and is composed of the proteins gliadine and glutenine. Gluten is responsible for the elasticity of kneaded dough which allows it to be leavened, as well as the ‘chewiness’ of baked products such as bagels. Gluten is found in most cereals (e.g., wheat, rye and barley) and products made with those cereals. Rice, soybean (soya), maize (corn), buckwheat, and sunflower seeds, for example, naturally do not contain gluten.

“Gluten-free diet” refers to a diet that excludes foods containing gluten protein. In some embodiments, a gluten-free diet may also be an organic diet.

“Gluten-free flour” refers to a powder or powder-like substance made of cereal grains, other seeds, or roots that are essentially free of gluten protein. The gluten-free flours used herein can be naturally gluten free or processed to eliminate its gluten content. As defined herein, “flour” encompasses ground or milled substances that are not fine; they can be coarse or even contain particles having a particle size, for example, of about 1 to about 100 microns or more, about 1 to about 50 microns, or about 50 to about 100 microns. In contrast, “powder,” “finely-ground powder,” or “superfine powder” refers to substances that are not coarse and can contain particles having a particle size, for example, of less than 50 microns, less than 25 microns, or less than 1 micron. In some embodiments, a distinction is made between, for example, milled white rice flour (e.g., particles greater than 1 micron) and finely-ground or superfine white rice powder (e.g., particles less than 1 micron). As used herein, “particle size” refers to the largest characteristic dimension (i.e. of a line passing through the geometric center of the particle e.g., diameter) that can be measured along any orientation of a particle (e.g., a polymer particle).

“Gluten-free food product” refers to a food product that does not contain (i.e. is essentially free of) gluten protein. In some embodiments, in addition to the gluten-free dry mix compositions described herein, gluten-free food products may comprise other gluten-free ingredients. Examples of other gluten-free ingredients include corn, potatoes, rice, and tapioca (derived from cassava, also referred to herein as tapioca flour), amaranth, arrowroot, millet, montina, lupin, quinoa, sorghum jowar), taro, teff, chia seed, yam, beans, soybean, and nut flours, buckwheat, and gram flour, derived from chickpeas. In some embodiments, the gluten-free dry mix compositions described herein exclude tapioca/tapioca flour. In some embodiments, the compositions described herein exclude bean and/or nut flours. Examples of bean flours include garbanzo bean flour (e.g., chickpea, gram, chana, besan, or cici flour), pinto bean flour, fava bean flour, navy bean flour, or other legume-based flour.

“Gluten-free ingredient” refers to any edible substance that forms or can be used to form part of a mixture (e.g., dry mixture) and that does not contain gluten protein. “Gluten-containing ingredient” refers to any edible substance that forms or can be used to form part of a mixture and that does contain (at least some) gluten protein.

“Gluten-reduced food product” refers to a food product that contains a reduced amount of gluten protein, relative to a food product made without taking measures to reduce the gluten content. For example, a gluten-reduced food product may contain any one of the gluten-free dry mix compositions described herein and additionally contain one or more ingredient that is not gluten-free. A gluten-reduced food product may also comprises a dry mix composition containing trace amounts of gluten protein.

“Guar gum” refers to a polysaccharide composed of the sugars galactose and mannose. Guar gum can be used as an emulsifier and/or as a stabilizer.

“Organic” refers to food products that are produced using methods that do not involve modern synthetic inputs such as synthetic pesticides and chemical fertilizers, no not contain genetically modified organisms, and are not processed using irradiation, industrial solvents, or chemical food additives. Any one of the food products (including, food, beverages, ingredients, dry mix compositions, and the like) may be organic or made with at least one organic component. In certain embodiments, organic food products or ingredients may meet the requirements of The Organic Foods Production Act (OFPA) of 1990 (Title 21 of P.L. 101-624, the Food, Agriculture, Conservation, and Trade Act of 1990) and/or may be certified as organic by an accredited certifying agent in the jurisdiction in which the food product or ingredient is produced and/or sold.

“Organoleptic properties” refers to the aspects of food or other substances as experienced by the senses, including taste, sight, smell, and touch. “Mouthfeel” refers to a product's physical and chemical interaction in the mouth and is evaluated from initial perception on the palate, to first bite, through mastication to swallowing and aftertaste. The gluten-free or gluten-reduced food products provided herein in certain embodiments have at least some organoleptic properties and mouthfeel comparable to their gluten-containing counterparts. For example, the organoleptic properties, including mouthfeel, of a chocolate chip cookie prepared with the gluten-free dry mix composition described herein may share substantially the same organoleptic properties of a chocolate chip cookie prepared following the same recipe but substituting wheat flour for the inventive gluten-free dry mix composition. The two cookies may look substantially the same, taste substantially the same, smell substantially the same, and/or feel substantially the same.

“Potato flour” refers to a Gluten free ground up potato. If the same process is followed for other vegetables, and then the result would be vegetable flour. Potato flour is different from potato starch.

“Prepackaged” food products or kits are those that are wrapped or packaged before marketing. Any one of the gluten-free or gluten-reduced dry mix compositions provided herein may be prepackaged. In instances wherein the inventive dry mix compositions are part of a prepackaged kit, such a kit can comprises a recipe or direction to obtain a recipe and/or one or more ingredients described in the recipe. A “recipe” means a set of instructions that describes how to prepare or make a food product, typically including a list of ingredients and step-by-step directions.

“Sorghum flour” refers to a gluten-free powder made from sorghum millet grain. Buckwheat, sorghum, oat flour, as well as many other grain flour are hearty grains. They can have very high fiber if ground whole, or less high fiber if it is hulled to various degrees. Other less refined or high refined flours may be included.

“Sweet rice flour” refers to a gluten-free powder made from high-starch, short-grain rice. Sweet rice flour can be used as a thickening agent.

“Wheat” means any Triticum species, including, but not limited to, T. aestivuin, T. monococcum, T. tauschii and T. turgidum. Thus, as used herein, the term “wheat” means any type of wheat including, but is not limited to, any cultivated wheat, any wild wheat, any wheat species, any intra- and inter-species wheat crosses, all wheat varieties, all wheat genotypes and all wheat cultivars. Cultivated wheats include, but are not limited to, einkom, durum and common wheats. “Barley” means a cereal grain derived from the annual grass Hordeum vulgare. “Rye” means a cereal grain (Secale cereale) that originated from either S. montanum or S. anatolicum and is closely related to wheat and barley. Wheat, barley, and rye each contain gluten protein.

“White rice flour” refers to a gluten-free powder made from polished rice (bran and germ removed). White rice flour can be used as a thickening agent. White rice may contain high levels of protein. In some embodiments, the white rice flour is superfine or finely-ground white rice flour (e.g., Authentic Foods White Rice Flour Superfine).

“Xanthan gum” refers to a high molecular weight polysaccharide gum produced by a pure-culture fermentation of a carbohydrate with Xanthomonas campestris, purified, for example, by recovery with ethanol or isopropanol, dried and milled. It contains D-glucose and D-mannose as the dominant hexose units, along with D-glucuronic acid and pyruvic acid, and may be prepared as the sodium, potassium or calcium salt. Xanthan gum, a natural thickener, may be used to add volume and viscosity to bread and other gluten-free baked goods.

### II. Compositions and Methods

Table 1 show the approximate ranges of ingredients for substitutes for embodiments for cookies white all purpose flour and whole wheat flours.

TABLE 1

| WHITE COOKIE FLOURS | | | HIGH FIBER COOKIE FLOURS | | |
|---|---|---|---|---|---|
| range | low | high | range | low | high |
| rice | 45% | 70% | rice | 0% | 10% |
| glutinous rice | 1% | 10% | glutinous rice | | |
| oat | 20% | 30% | oat | 60% | 90% |
| millet | 4% | 10% | millet | 10% | 30% |
| potato flour | >0% | 4% | potato flour | >0% | 4% |
| teff flours | >0% | 4% | teff flours | >0% | 4% |
| buckwheat flours | >0% | 4% | buckwheat flours | >0% | 4% |

ranges are inclusive

For additional embodiments, increase rice flour, then it may work for cakes as a substitute for white all purpose flour and whole wheat flours.
For additional embodiments add a gum or other texture additives and adjust the other ingredients, you get a flour that will work for bread recipes.
For additional embodiments add xanthan and/or gaur gum and or maltodextrin and adjust the other ingredients, you get a flour that will work for bread recipes.
These examples illustrate the range of ingredients in Table 2

TABLE 2

| WHITE FLOURS | | | HIGH FIBER FLOURS | | |
|---|---|---|---|---|---|
| range | low | high | range | low | high |
| rice | 45% | 70% | rice | 0% | 25% |
| glutinous rice | 0% | 10% | glutinous rice | 0% | 2% |
| oat | 20% | 30% | oat | 60% | 90% |
| millet | 4% | 10% | millet | 10% | 30% |
| potato flour | >0% | 4% | potato flour | >0% | 4% |
| grain flours | 0% | 4% | grain flours | 0% | 4% |
| seed flours | 0% | 4% | seed flours | 0% | 4% |
| xanthan gum | 0% | 2% | xanthan gum | 0% | 2% |
| gaur gum | 0% | 2% | gaur gum | 0% | 2% |
| maltodextrin | 0% | 2% | maltodextrin | 0% | 2% |

ranges are inclusive

Certain aspects of the invention disclosed herein relate to gluten-free dry mix compositions comprising in certain embodiments at least two of white rice flour, sweet rice flour, millet flour, buckwheat, oat flour, potato flour, and optionally a gum. In some embodiments, the gum is a guar gum, while in some embodiments, it is xanthan gum. In certain embodiments, the compositions further comprise maltodextrin. In some embodiments, the compositions further comprise ascorbic acid and/or ginger. In particular embodiments, provided herein are gluten-free or gluten-reduced dry mix compositions comprising or consisting essentially of white rice flour, sweet rice flour, oat flour, millet flour, buckwheat, potato flour, and a texture additive. In particular embodiments, provided herein are gluten-free or gluten-reduced dry mix compositions comprising or consisting essentially of white rice flour, sweet rice flour, oat flour, millet flour, buckwheat, potato flour. In particular embodiments, provided herein are gluten-free or gluten-reduced dry mix compositions comprising or consisting essentially of oat flour, millet flour, buckwheat, potato flour, and a texture additive. In particular embodiments, provided herein are gluten-free or gluten-reduced dry mix compositions comprising or consisting essentially of oat flour, millet flour, buckwheat, potato flour. In particular embodiments, provided herein are gluten-free or gluten-reduced dry mix compositions comprising or consisting essentially of oat flour, white rice flour, millet flour, buckwheat, potato flour and a texture additive. In particular embodiments, provided herein are gluten-free or gluten-reduced dry mix compositions comprising or consisting essentially of oat flour, millet flour, buckwheat, potato flour. Any one of these compositions may be suitable for use as a 1:1 substitute for gluten-containing flours, such as wheat, barley, and/or rye flour. Food products, related methods of preparing such food products, and prepackaged kits comprising the inventive dry mix compositions are also described herein. In some embodiments the amount of flour is significantly different than the original recipe. For example bread recipes often require different a amount of flour.

TABLE 3

| Over all range | | | |
|---|---|---|---|
| range | low | high | percentage claimed |
| rice | 0% | 80% | 0 to 1%, 1 to 2%, . . . , 79 to 80% |
| glutinous rice | 0% | 30% | 0 to 1%, 1 to 2%, . . . , 29 to 30% |
| oat | 0% | 90% | 0 to 1%, 1 to 2%, . . . , 89 to 90% |
| millet | >0% | 30% | greater than 0 to 1%, 1 to 2%, . . . , |
| | | | 29 to 30% |
| potato flour | >0% | 10% | greater than 0 to 1%, 1 to 2%, . . . , |
| | | | 9 to 10% |
| buckwheat flour | 0% | 10% | 0 to 1%, 1 to 2%, . . . , 9 to 10% |
| teff flour | 0% | 10% | 0 to 1%, 1 to 2%, . . . , 9 to 10% |
| grain flours | 0% | 10% | 0 to 1%, 1 to 2%, . . . , 9 to 10% |
| seed flours | 0% | 10% | 0 to 1%, 1 to 2%, . . . , 9 to 10% |
| xanthan gum | 0% | 2% | 0 to 0 .1%, 0.1 to 2%, . . . , 1.9 to 2% |
| gaur gum | 0% | 2% | 0 to 0 .1%, 0.1 to 2%, . . . , 1.9 to 2% |
| maltodextrin | 0% | 2% | 0 to 0 .1%, 0.1 to 2%, . . . , 1.9 to 2% |

ranges are inclusive

In some embodiments, different embodiments can be combined to create a blend that will work best for a certain recipe. By the way of example, but not limited to, an embodiment for cakes and an embodiment for cookies, can be combined for banana bread. By this method, a few flours and combine them in various rations for many more recipes. Examples of factors that could vary the recipe that
1. could depend on availability of ingredients or preferences.
2. Some kinds of millet seeds are milder, so you can have a higher percentage.
3. The more complete hulled the buckwheat the higher the percent that can be used
4. how fine of a grind on the flours you have may affect how much texture additives you need
5. How refined the flours
6. desired level of fiber in blend.

In certain embodiments, other gluten free flours are included such as teff flour, ancient grain flours, amaranth, teff, quinoa. In certain embodiments, whole or ground seeds could also be added. In certain embodiments, barley and other non-wheat flours for those who have a problem with wheat but not all glutens. In certain embodiments, comprising at least one of the following; xanthan gum, gaur gum, maltodextrin, dextrin, emulsifiers, psyllium, and stabilizers. In certain embodiments, comprising at least one of the following; soy, milk, whey, protein isolates, or high proteins substances to make a higher proteins flour. In certain embodiments, tapioca flour is excluded from the dry mix compositions described herein. In certain embodiments, bean flour is excluded from the dry mix compositions described herein.

Other aspects provided herein relate methods of preparing a food product having a recipe that requires wheat, barley and/or rye flour and at least one other ingredient, the methods comprising combining the gluten-free dry mix composition of any one of the embodiments described herein with at least one other ingredient in the recipe. In some embodiments, a gluten-free dry mix composition is used to substitute for wheat, barley, and/or rye flour ingredients in the recipe. In other embodiments, a gluten-free dry mix composition substitutes for only a portion of the wheat, barley, or rye flour ingredients in the recipe. In such embodiments, a gluten-reduced (rather than a gluten-free) food product is prepared. For example, in a recipe requiring 2 cups of wheat flour, 1 of the 2 cups of wheat flour can be substituted with (replaced by) any one of the gluten-free dry mix compositions described herein. In some embodiments the amount of flour is significantly different than the original recipe. For example bread recipes often require different a amount of flour.

Still other aspects provided herein relate to methods of preparing a food product based on a recipe that requires wheat, barley and/or rye flour and at least one other ingredient, the methods comprising combining oat flour, millet flour with at least one other ingredient in the recipe. In some embodiments, the methods further comprise combining rice flour In some embodiments, the methods further comprise combining sweet rice flour. In some embodiments, the methods further comprise combining teff flour. In some embodiments, the methods further comprise combining buckwheat flour. In some embodiments, the methods further comprise combining ascorbic acid and/or ginger. In some embodiments, the methods further comprise combining xanthan gum. In some embodiments, the methods further comprise combining gaur gum. In some embodiments, the methods further comprise combining maltodextrin.

In certain embodiments, additional ingredients not listed in the recipe are excluded during preparation of the food product (and excluded from the final food product) and the amount of each ingredient in the recipe is not altered. It is known to one of ordinary skill in the art that when Gluten free flour blends or flours, such as sorghum flour, are used in place of, e.g., wheat flour, it is often necessary to alter other ingredients in the recipe to compensate for the properties that are lost or negatively affected by omitting gluten. For example, extra oil or shortening may be necessary to impart moisture to the wheat-free food product, an extra egg or two may be required to improve smoothness and crumb structure, or extra baking powder and/or baking soda may be necessary to boost rising properties. Such “altered” amounts and/or types of ingredients may not be necessary with the Gluten free or gluten-reduced dry mix compositions of certain embodiments described herein. Certain embodiments of the inventive compositions may be used as a direct 1:1 substitution (about 1:1) for gluten-based flours, such as wheat, barley, and/or rye flour, without the addition of extra ingredients/amounts of required ingredients.

Yet other aspects provided herein relate to gluten-free or gluten-reduced food products. Gluten-free food products may comprise any one of the gluten-free dry mix compositions provided herein or may comprises the ingredients used to make the gluten-free dry mix compositions. Such food products may be gluten-free or substantially gluten-free. Gluten-reduced food products may comprise any one of the gluten-free dry mix compositions provided herein or may comprise ingredients used to make the gluten-free dry mix compositions, and additionally, one or more ingredients comprising gluten. Examples of gluten-free or gluten-reduced food products include, but are not limited to, angel food cake, biscotti, biscuits, Boston cream pie, bread pudding, bread, dinner roll, dough, doughnuts, brownie, bundt cake, cakes, cinnamon rolls, cookie, cheese cake, chips, cracker, croissants, cupcakes, danish, eclair, florentine, French pastries, fruit cakes, fudge, coffee cakes, lemon squares, liqueur cake, loave, muffin, noodles, pasta, pie dough, puff pastry turnover, pancake, pie, pineapple upside down cake, pizza dough, pretzels, quiche, quick bread, red velvet cake, sticky bun, strudel, stuffing, tart, tiramisu, torte, tres leche cake, trifle, and wedding cake.

Aspects provided herein also relate to prepackaged dry mixes comprising any one of the gluten-free dry mix compositions described herein, optionally also including one or more additional ingredients (e.g., gluten-free ingredients), and a recipe or directions for obtaining a recipe for preparing a food product using the gluten-free dry mix composition and the additional ingredients.

The function and advantage of these and other embodiments of the present invention may be more fully understood from the examples below. The following examples, while illustrative of certain embodiments of the invention, do not exemplify the full scope of the invention.

### EXAMPLES

### Example 1. Chocolate Chip Cookies

Ingredients: 2¼ cups gluten-free dry mix composition (finely-ground white rice flour, sweet rice flour, potato starch, sorghum flour, xanthan gum, cornstarch, ascorbic acid, and ginger), 1 teaspoon baking soda, 1 teaspoon salt, 1 cup (2 sticks) butter, softened, ¾ cup granulated sugar, ¾ cup packed brown sugar, 1 teaspoon vanilla extract, 2 large eggs, 2 cups (12-oz. pkg.) NESTLE® TOLL HOUSE® Semi-Sweet Chocolate Morsels, 1 cup chopped nuts. Directions: Preheat oven to 375° F. Combine flour, baking soda and salt in small bowl. Beat butter, granulated sugar, brown sugar and vanilla extract in large mixer bowl until creamy. Add eggs, one at a time, beating well after each addition. Gradually beat in flour mixture. Stir in morsels and nuts. Drop by rounded tablespoon onto ungreased baking sheets. Bake for 9 to 11 minutes or until golden brown. Cool on baking sheets for 2 minutes; remove to wire racks to cool completely.

### Example s Sour Cream Coffee Cake

Ingredients: ½ cup butter, 1 cup sugar, 1 cup sour cream, 1 teaspoon vanilla, 2 eggs, 2 cups gluten-free dry mix composition (finely-ground white rice flour, sweet rice flour, potato starch, sorghum flour, xanthan gum, cornstarch, ascorbic acid, and ginger), 1 teaspoon baking powder, and 1 teaspoon baking soda. Nut topping: ½ teaspoon cinnamon, ½ cup chopped walnuts, and ½ cup firmly packed brown sugar. Directions: spoon ½ of the cake batter into the pan. Sprinkle with ½ of the nut topping. Spoon in remaining batter and top with remaining nut topping. Bake at 375° F. for 30-45 minutes depending on pan size.

### Example 3. Carrot Cake

Ingredients: 2 cups gluten-free dry mix composition (finely-ground white rice flour, sweet rice flour, potato starch, sorghum flour, xanthan gum, cornstarch, ascorbic acid, and ginger), 2 cups sugar, 1 teaspoon baking powder, 1 teaspoon baking soda, 1 teaspoon ground cinnamon, 3 cups of finely shredded carrot, 1 cup cooking oil, and 4 eggs.

Directions: preheat oven to 350° F. In a bowl, combine flour, sugar, baking powder, baking soda, and cinnamon. Add carrot, oil, and eggs. Beat with an electric mixer until all ingredients are combined. Pour into two greased and floured 9×1% inch round baking pans. Bake in a 350° F. oven for 20-35 minutes. Cool on wire rack for 10 minutes. Remove cakes from pan and cool thoroughly.

In some embodiments the amount of flour is significantly different than the original recipe. For example bread recipes often require different a amount of flour.

For example for pizza dough from allrecipes.com, the original recipe requires about 300 grams, but the gluten free recipes requires about 280 grams. In some recipes, the difference is even greater.

While several embodiments of the invention have been described and illustrated herein, those of ordinary skill in the art will readily envision a variety of other means and structures for performing the functions and/or obtaining the results or advantages described herein, and each of such variations, modifications and improvements is deemed to be within the scope of the present invention. More generally, those skilled in the art would readily appreciate that all parameters, dimensions, materials, and configurations described herein are meant to be exemplary and that actual parameters, dimensions, materials, and configurations will depend upon specific applications for which the teachings of the present invention are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described. The present invention is directed to each individual feature, system, material and/or method described herein. In addition, any combination of two or more such features, systems, materials and/or methods, provided that such features, systems, materials and/or methods are not mutually inconsistent, is included within the scope of the present invention.

In the claims (as well as in the specification above), all transitional phrases or phrases of inclusion, such as “comprising,” “including,” “carrying,” “having,” “containing,” “composed of,” “made of,” “formed of,” “involving” and the like shall be interpreted to be open-ended, i.e. to mean “including but not limited to” and, therefore, encompassing the items listed thereafter and equivalents thereof as well as additional items. Only the transitional phrases or phrases of inclusion “consisting of and “consisting essentially of are to be interpreted as closed or semi-closed phrases, respectively. The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified. Thus, as a non-limiting example, a reference to “A and/or B” can refer, in one embodiment, to A only (optionally including elements other than B); in another embodiment, to B only (optionally including elements other than A); in yet another embodiment, to both A and B (optionally including other elements); etc. As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of or “exactly one of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.”

As used herein in the specification and in the claims, the phrase “at least one,” in reference to a list of one or more elements, should be understood, unless otherwise indicated, to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements that the phrase “at least one” refers to, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In some of the above embodiments, wherein said comprises only of flours that are grain, seed, vegetable flours, or spices.
With some of the above embodiments gluten-free or gluten reduced food product comprising the gluten-free dry mix composition of any one of any of the above claims.

In some embodiments, different embodiments can be combined to create a blend that will work best for a certain recipe. By the way of example, but not limited to, an embodiment for cakes and an embodiment for cookies, can be combined for banana bread. By this method, a few flours and combine them in various rations for many more recipes. Gluten-free and gluten-reduced food products further comprise ginger.

A food product based on a recipe that requires wheat, barley or rye flour and at least one other ingredient, said method comprising combining the gluten-free dry mix composition of any one of any of the above embodiments with the at least one other ingredient in the recipe, wherein the wheat, barley, or rye flour ingredient is substituted with an equivalent amount of the gluten-free dry mix composition, and wherein the prepared food product is gluten-free.
In some of the above embodiments, wherein additional ingredients not listed in the recipe are excluded from the gluten-free food product and wherein the amount of each ingredient in the recipe is not altered.
In some of the above embodiments, a gluten-free or gluten reduced food product
With some of the above embodiments, gluten-free food product using any of the above embodiments wherein the food product is selected from the group consisting of: angel food cake, biscotti, biscuits, Boston cream pie, bread pudding, bread, dinner roll, dough, doughnuts, brownie, bundt cake, cakes, cinnamon rolls, cookie, cheese cake, chips, cracker, croissants, cupcakes, danish, eclair, florentine, French pastries, fruit cakes, fudge, coffee cakes, lemon squares, liqueur cake, loaf, muffin, noodles, pasta, pie dough, puff pastry turnover, pancake, pie, pineapple upside down cake, pizza dough, pretzels, quiche, quick bread, red velvet cake, sticky bun, strudel, stuffing, tart, tiramisu, torte, tres leche cake, trifle, and wedding cake.
A gluten-reduced food product comprising the gluten-free dry mix composition of any one of any of the above embodiments and one or more additional gluten-containing ingredients.
A prepackaged gluten-free or gluten reduced food product kit comprising the gluten-free dry mix composition of any of the above embodiments and a recipe or directions for obtaining a recipe for preparing a food product using the gluten-free dry mix composition. The kit, wherein the kit further comprises at least one additional ingredient that is listed in the recipe.
A gluten-free blend that is mass produced comprising the gluten-free dry mix composition of any of the above embodiments.

In cases where the present specification and a document incorporated by reference and/or referred to herein include conflicting disclosure, and/or inconsistent use of terminology, and/or the incorporated/referenced documents use or define terms differently than they are used or defined in the present specification, the present specification shall control.

PatentCited

| Patent | Filing date | Publication date | Applicant | Title |
|---|---|---|---|---|
| US20050158446 * | Jan. 21, 2004 | Jul. 21, 2005 | Lester Linda K. | Savory gluten-free foods |
| US20090098270 * | Aug. 13, 2008 | Apr. 16, 2009 | Cargill, Incorporated | System for gluten |
| replacement in food products | | | | |
| US20090123627 * | Oct. 23, 2008 | May 14, 2009 | Shepard Jules E D | Gluten-free flour |
| composition | | | | |
| US20100297323 * | Jan. 8, 2010 | Nov. 25, 2010 | Solazyme, Inc. | Gluten-free Foods Containing |
| Microalgae | | | | |
| WO2013043659A1 | Sep. 19, 2012 | Mar. 3, 2013 | Stefanie Papanastasiou | Gluten-free dry mix |
| composition | | | | |
| US20090098270 * | Aug. 13, 2008 | Apr. 16, 2009 | Cargill, Incorporated | System for gluten |
| replacement in food products | | | | |
| US20090123627 * | Oct. 23, 2008 | May 14, 2009 | Shepard Jules E D | Gluten-free flour |
| composition | | | | |
| US20070160728A1 | Oct.13, 2005 | Jul. 12, 2007 | Noel Rudy | Gluten-free food products |
| including deflavored bean powder | | | | |
| WO2012115781A1 | Feb. 2, 2011 | Aug. 8, 2012 | Li Zhang | Composition comprising gluten- |
| free cereal flour | | | | |
| WO2011062507A1 | Nov. 18, 2010 | May 26, 2011 | Sudrud Sorensen | Dough for gluten-free |

pastries, method for production for such gluten-free pastries, set for production of gluten-free pastries
and use of such dough for production of gluten-free pastries

| | | | | |
|---|---|---|---|---|
| US20110027421 * | Jun. 25, 2010 | Feb. 3, 2011 | U&S Unismack S.A. | Gluten-free food |

compositions comprising cheese, starch, and gluten-free flour and methods for making the same

| | | | | |
|---|---|---|---|---|
| CN102018011A | Oct. 28, 2010 | Apr. 20, 2011 | | |
| US20130040016A1 | Aug. 15, 2012 | Fev 14, 2013 | Larua Lane Becker | Allergen-free |
| composistions | | | | |
| WO2014035470A1 | Mar. 8, 2013 | Mar. 6, 2014 | | High protein meal and flour |
| compostions and methods | | | | |
| EP20120716521 | Mar. 16, 2012 | May 4, 2016 | Karsten Karcher | Gluten-free composition for |
| bakery | | | | |
| US20110117246 * | Jul. 15, 2009 | May 19, 2011 | Cargill, Incorporated | Composition for |

preparing improved gluten-free or gluten-reduced bakery products

| | | | | |
|---|---|---|---|---|
| WO2014193417A1 * | May 31, 2013 | Dec. 4, 2014 | General Mills, Inc. | Ready-to-bake gluten- |

free pizza dough formulations

| | |
|---|---|
| U.S. Classification | 426/72, 426/622, 426/637, A21D13/066 |
| International Classification | A23L1/2165, A23L1/10, A21D10/00, A23L1/00, C08L3/00 |

| | |
|---|---|
| Cooperative Classification | A23L1/2165, A23V2002/00, A23L1/1041, A21D10/005, A23L1/1041, |

A21D13/04, C08L99/00, A21D2/183, A21D2/186, A21D13/066

Composition comprising gluten-free cereal flour

EP 2677873 A1
CN103369965A, CN1033699656, US20130323354, WO2012115781A1
Gluten-free composition for bakery
EP 2685833 B1

1. A gluten-free dry mix composition, comprising of oat flour; millet flour; and potato flour.

2. The gluten-free dry mix composition of claim 1, comprising of oat flour, millet flour, potato flour and one or more of: white rice flour; sweet rice flour; ginger; buckwheat flour; teff flour, a whole or less refined grain flour.

3. The gluten-free dry mix composition of claim 1, comprising of oat flour, millet flour, potato flour wherein oat flour, millet flour, and potato flour is present in an amount of at least about 20% w/w of the dry mix composition.

4. The gluten-free dry mix composition of claim 3, wherein the oat flour is present in an amount of about 60% to about 90% w/w of the dry mix composition; millet flour in the range of 10 to 30 percent by weight; potato flour in the range of 0 to 4 percent by weight;

5. The gluten-free dry mix composition of claim 4, wherein the oat flour is present in an amount of about 60% to about 90% w/w of the dry mix composition; millet flour in the range of 10 to 30 percent by weight; potato flour in the range of 0 to 4 percent by weight; (i) buckwheat flour in the range of 0 to 4 percent by weight, (j) teff flour in the range of 0 to 4 percent by weight

6. The gluten-free dry mix composition of claim 5, wherein the oat flour is present in an amount of about 60% to about 90% w/w of the dry mix composition; millet flour in the range of 10 to 30 percent by weight; potato flour in the range of 0 to 4 percent by weight; (i) xanthan gum flour in the range of 0 to 4 percent by weight, (j) maltodextrin flour in the range of 0 to 4 percent by weight, (k) gaur gum flour in the range of 0 to 4 percent by weight

7. The gluten-free dry mix composition of claim 3, wherein the oat flour is present in an amount of about 60% to about 90% w/w of the dry mix composition; millet flour in the range of 10 to 30 percent by weight; potato flour in the range of 0 to 4 percent by weight; (i) xanthan gum flour in the range of 0 to 4 percent by weight, (j) maltodextrin flour in the range of 0 to 4 percent by weight, (k) gaur gum flour in the range of 0 to 4 percent by weight; (l) buckwheat flour in the range of 0 to 4 percent by weight, (m) teff flour in the range of 0 to 4 percent by weight

8. The gluten-free dry mix composition of claim 7, wherein rice flour in the range of 0 to 25 percent inclusively by weight; oat flour in the range of 60 to 90 percent by weight; millet flour in the range of 10 to 30 percent by weight; glutinous rice flour in the range of 0 to 2 percent by weight; potato flour in the range of 0 to 4 percent by weight; a grain flour in the range of 0 to 4 percent inclusively by weight; a seed flour in the range of 0 to 4 percent inclusively by weight; xanthan gum in the range of 0 to 2 percent inclusively by weight; gaur gum in the range of 0 to 2 percent inclusively by weight; and maltodextrin in the range of 0 to 2 percent inclusively by weight.

9. The gluten-free dry mix composition of claim 1, wherein it also comprising white rice flour.

10. The gluten-free dry mix composition of claim 9, wherein it also comprising sweet rice flour.

11. The gluten-free dry mix composition of claim 9 comprising: rice flour in the range of 45 to 70 percent by weight; oat flour in the range of 10 to 30 percent by weight; millet flour in the range of 4 to 10 percent by weight; potato flour in the range of 0 to 4 percent by weight;

12. The gluten-free dry mix composition of claim 11 comprising: rice flour in the range of 45 to 70 percent by weight; oat flour in the range of 10 to 30 percent by weight; millet flour in the range of 4 to 10 percent by weight; potato flour in the range of 0 to 4 percent by weight; buckwheat flour in the range of 0 to 4 percent by weight, teff flour in the range of 0 to 4 percent by weight, sweet rice flour in the range of 0 to 20 percent by weight

13. The gluten-free dry mix composition of claim 12 comprising: rice flour in the range of 45 to 70 percent by weight; oat flour in the range of 10 to 30 percent by weight; millet flour in the range of 4 to 10 percent by weight; potato flour in the range of 0 to 4 percent by weight; (i) xanthan gum flour in the range of 0 to 4 percent by weight, (j) maltodextrin flour in the range of 0 to 4 percent by weight, (k) gaur gum flour in the range of 0 to 4 percent by weight

14. The gluten-free dry mix composition of claim 13 comprising: rice flour in the range of 45 to 70 percent by weight; oat flour in the range of 10 to 30 percent by weight; millet flour in the range of 4 to 10 percent by weight; potato flour in the range of 0 to 4 percent by weight; (i) xanthan gum flour in the range of 0 to 4 percent by weight, (j) maltodextrin flour in the range of 0 to 4 percent by weight, (k) gaur gum flour in the range of 0 to 4 percent by weight (i) buckwheat flour in the range of 0 to 4 percent by weight, (j) teff flour in the range of 0 to 4 percent by weight; sweet rice flour in the range of 0 to 20 percent by weight

15. The gluten-free dry mix composition of claim 14 comprising: rice flour in the range of 45 to 70 percent by weight; oat flour in the range of 20 to 30 percent by weight; millet flour in the range of 4 to 10 percent by weight; glutinous rice flour in the range of 0 to 10 percent inclusively by weight; potato flour in the range of 0 to 4 percent by weight; a grain flour in the range of 0 to 4 percent inclusively by weight; a seed flour in the range of 0 to 4 percent inclusively by weight; xanthan gum in the range of 0 to 2 percent inclusively by weight; gaur gum in the range of 0 to 2 percent inclusively by weight; and maltodextrin in the range of 0 to 2 percent inclusively by weight.

16. The gluten-free dry mix composition of claim 1 comprising: rice flour in the range of 0 to 80 percent inclusively by weight; oat flour in the range of 10 to 90 percent by weight; millet flour in the range of 0.01 to 30 percent by weight; glutinous rice flour in the range of 0 to 10 percent inclusively by weight; potato flour in the range of 0 to 10 percent by weight; a grain flour in the range of 0 to 10 percent inclusively by weight; a seed flour in the range of 0 to 10 percent inclusively by weight; xanthan gum in the range of 0 to 2 percent inclusively by weight; gaur gum in the range of 0 to 2 percent inclusively by weight; and maltodextrin in the range of 0 to 2 percent inclusively by weight.

17. A gluten-free dry mix composition, comprising of millet flour, potato flour, a rice flour and at least one less refined grain flour;

18. The gluten-free dry mix composition of claim 17, comprising of buckwheat flour, millet flour, potato flour, white rice flour; sweet rice flour; ginger;

19. The gluten-free dry mix composition of claim 18, wherein the rice flour is about 30 to 40% of the blend and the sweet rice is about 30% to 40% of the blend

20. The gluten-free dry mix composition of claim 19, wherein the rice is present in an amount of about 30 to 40 percent by weight; the sweet rice is present in an amount of about 30 to 40 percent by weight; millet flour in the range of 10 to 20 percent by weight; potato flour in the range of 0 to 4 percent by weight
